(19) United States
(12) Patent Application Publication
(10) Pub. No.: US 2025/0206127 A1
(43) Pub. Date: Jun. 26, 2025

(54) HYBRID DRIVE SYSTEM FOR A MOTOR VEHICLE, AND MOTOR VEHICLE, IN PARTICULAR MOTOR CAR

(71) Applicant: MERCEDES-BENZ GROUP AG, Stuttgart (DE)

(72) Inventors: Tobias SCHILDER, Ludwigsburg (DE); Klaus RIEDL, Tübingen (DE); Joerg MUELLER, Chemnitz (DE); Rico RESCH, Chemnitz (DE); Martin STOECKER, Oelsnitz, Ortsteil Neuwuerschnitz (DE)

(21) Appl. No.: 18/844,558

(22) PCT Filed: Feb. 28, 2023
(86) PCT No.: PCT/EP2023/054958

§ 371 Date: Sep. 6, 2024

(30) Foreign Application Priority Data
Mar. 9, 2022 (DE) 10 2022 000 830.0

(51) Int. Cl. B60K 6/365; B60K 6/48; B60K 6/547

(52) U.S. Cl. CPC B60K 6/365; B60K 6/48; B60K 6/547; B60K 2006/4825

(57) ABSTRACT

A hybrid drive system for a motor vehicle includes an internal combustion engine having a drive shaft via which first drive torques can be provided by the internal combustion engine and an electric machine having a rotor via which second drive torques can be provided by the electric machine. An axial transmission has an axial transmission input gear via which the axial transmission can be driven. The system also includes a transmission having a first partial transmission and a second partial transmission. The first partial transmission has a first planetary gear set having a first element, a second element, and a third element. A second planetary gear set has a fourth element, a fifth element, and a sixth element that is permanently connected to the second element in a manner fixed against rotation. The second partial transmission comprises a first spur gear stage and a driven shaft.

### BACKGROUND AND SUMMARY OF THE INVENTION

Exemplary embodiments of the invention relate to a hybrid drive system for a motor vehicle, in particular a motor car, as well as to a motor vehicle having such a hybrid drive system.

DE 10 2011 080 566 A1 discloses a splitter transmission having two planetary gear sets and a countershaft arranged in parallel with the planetary gear sets.

A hybrid transmission that has a planetary design is known from DE 10 2018 000 183 A1.

DE 10 2017 006 082 A1 and the generic DE 10 2015 223 026 A1 respectively disclose a hybrid drive device having an internal combustion engine and an electric machine that has a rotor, wherein a transmission is provided that comprises two partial transmissions, specifically a first partial transmission having two planetary gear sets and a second partial transmission having at least two spur gear stages.

Exemplary embodiments of the present invention are directed to a hybrid drive system for a motor vehicle, and a motor vehicle having such a hybrid drive system, such that a particularly compact, and simultaneously high-performing drive can be implemented.

A first aspect of the invention relates to a hybrid drive system also described as a hybrid drive device or hybrid drive apparatus or in the form of a hybrid drive apparatus or hybrid drive device for a motor vehicle, in particular for a motor car. This means that in its finished state, the motor vehicle in particular in the form of a motor car, most particularly in the form of a passenger car, has the hybrid drive system and can be driven by means of the hybrid drive system.

The hybrid drive system has an internal combustion engine, also described as a combustion machine or internal combustion machine, having a drive shaft. For example, the internal combustion engine is in the form of a reciprocating piston engine, such that the drive shaft is most particularly in the form of a crankshaft. The internal combustion engine can provide first drive torques to drive the motor vehicle via the drive shaft. The first drive torques are first torques for driving the motor vehicle.

The hybrid drive system additionally comprises an electric machine that has a rotor. For example, the electric machine has a stator, by means of which the rotor can be driven and can thus be rotated around a machine axis of rotation relative to the stator. The electric machine can provide second drive torques via the rotor to drive the motor vehicle. The second drive torques are second torques for driving the motor vehicle.

In its finished state, for example, the motor vehicle has at least or exactly two vehicle axles, also simply described as axles, arranged one behind the other, and thus one after the other, in the longitudinal direction of the vehicle. The respective axle has at least or exactly two vehicle wheels, also simply described as wheels, which are arranged on opposite sides in the transverse direction of the motor vehicle also described as a vehicle. The respective wheel is a ground contact element via which the motor vehicle is or can be supported downwards in the vertical direction of the vehicle on the ground. If the motor vehicle travels over the ground, and is driven by means of the hybrid drive system, while the motor vehicle is supported downwards in the vertical direction of the vehicle on the ground via the ground contact elements, then the ground contact elements roll, in particular directly, along the ground.

The hybrid drive system is assigned, for example, to one, in particular exactly one, of the axles, such that, for example, the wheels of the axle to which the hybrid drive system is assigned can be driven by means of the hybrid drive system. Thus, it is in particular conceivable that the internal combustion engine (via its drive shaft) and the electric machine (via its rotor) can drive the same wheels of the axle to which the hybrid drive system is assigned. The motor vehicle can be driven by driving the wheels. The wheels that can be driven by means of the hybrid drive system, and thus by means of the internal combustion engine and by means of the electric machine, are also described as drivable or driven wheels or as driven or drivable vehicle wheels. Where “the wheels” or “the vehicle wheels” are mentioned in the following, the wheels of the axle to which hybrid drive system is assigned that can be driven by means of the hybrid drive system are meant unless otherwise specified.

The hybrid drive system comprises an axial transmission, which is in particular assigned to the axle. In particular, the wheels can be driven by the internal combustion engine and by the electric machine via the axial transmission. The axial transmission is most particularly a differential transmission (also simply described as a differential), which, in particular, has the function well known from the general prior art that a respective third torque can be distributed across the wheels via the axial transmission, such that the wheels can be driven by means of the respective third torque via the axial transmission. For example, the respective third torque results from the respective first drive torque and/or from the respective second drive torque. In particular, the axial transmission, for example, permits the wheels to have different rotational speeds while the motor vehicle is driving around a bend, such that, for example, the wheel on the outside of the bend can rotate at a greater rotational speed than the wheel on the inside of the bend, in particular while the wheels are or can be driven by means of the third torque or by the internal combustion engine and/or by the electric machine via the axial transmission. The axial transmission has an axial transmission input gear via which the axial transmission can be driven, in particular such that the respective third torque can be introduced into the axial transmission or transmitted to the axial transmission via the axial transmission input gear. The axial transmission input gear is a first gearwheel of the hybrid drive system, i.e., is also described as a first gearwheel of the hybrid drive system. For example, the axial transmission input gear can be in the form of a crown gear. The axial transmission can be in the form of a bevel gear differential or, for example, as a planetary transmission differential.

The hybrid drive system additionally has a transmission (also described as a main transmission) which, in particular, is provided in addition to the axial transmission, the transmission having a first partial transmission and a second partial transmission. In particular, it is conceivable that the axial transmission can be driven by the internal combustion engine and by the electric machine via the transmission, such that, for example, the transmission can provide the respective third torque, or the transmission can for example provide its respective fourth torque, from which, for example, the respective third torque results. For example, it is conceivable for the respective fourth torque to result from the respective first drive torque and/or from the respective second drive torque.

The first partial transmission has a first planetary gear set, which is also simply described as a first planetary set. The first planetary gear set has a first sun gear, a first planetary carrier, which is also described as a first stage, and a first annular gear. The first sun gear, the first planetary carrier, and the first annular gear are also described as planetary gear set elements of the first planetary gear set, and thus the first sun gear, the first planetary carrier and the first annular gear are planetary gear set elements of the first planetary gear set. A first of the planetary gear set elements is also described as a first element, a second of the planetary gear set elements is also described as a second element, and the third planetary gear set element of the first planetary gear set is also described as a third element.

The first partial transmission additionally has a second planetary gear set, in particular, provided in addition to the first planetary gear set, the second planetary gear set also simply being described as a second planetary set. In particular, the second planetary gear set has a second sun gear, a second planetary carrier, which is also described as a second stage, and a second annular gear. The second sun gear, the second planetary carrier and the second annular gear are also described as transmission elements of the second planetary gear set, and they are thus transmission elements of the second planetary gear set.

A first of the transmission elements of the second planetary gear set is also described as a fourth element, a second of the transmission elements of the second planetary gear set is also described as a fifth element, and the third transmission element of the second planetary gear set is also described as a sixth element. Where “the elements” are mentioned in the following, the previously specified six elements of the planetary gear sets, specifically the first element, the second element, the third element, the fourth element, the fifth element, and the sixth element, should be understood to be meant unless otherwise specified.

In particular, it is conceivable that the hybrid drive system has a housing, wherein it is conceivable for the first planetary gear set and/or the second planetary gear set to be respectively arranged at least partially, in particular at least substantially and thus at least more than half or entirely in the housing. For example, if the respective planetary gear set element is not connected to the housing in a manner fixed against rotation, the respective planetary gear set element can be rotated around a first planetary gear set axis of rotation relative to the housing, in particular by driving the first planetary gear set. It is further conceivable that, in particular if the respective transmission element is not connected to the housing in a manner fixed against rotation, the respective transmission element can be rotated around a second planetary gear set axis of rotation relative to the housing, in particular by driving the second planetary gear set. In particular, it can be provided that the planetary gear sets are arranged coaxially with each other, such that the planetary gear set axes of rotation coincide.

The second element is permanently connected to the sixth element in a manner fixed against rotation.

The second partial transmission has a first spur gear stage and a driven shaft that is, in particular, provided in addition to the drive shaft. The spur gear stage, for example, comprises two, in particular exactly two, gearwheels, in particular in the form of spur gears, specifically a second gearwheel and a third gearwheel. In particular, it is conceivable for the gearwheels of the spur gear stage to interlock with one another, in particular directly and/or permanently. The feature that two gearwheels, e.g., the second gearwheel and the third gearwheel, permanently interlock with one another, and are thus permanently engaged with each other, should be understood to mean that the permanently interlocking gearwheels cannot be moved relative to one another between an interlocking position in which the gearwheels interlock with one another and a released position in which the gearwheels do not interlock with one another, and instead the permanently interlocking gearwheels are permanently, i.e., always, engaged with each other.

The first spur gear stage has a first output gearwheel, which is, for example, the previously specified second gearwheel of the spur gear stage. The first output gearwheel is arranged coaxially with the driven shaft. In particular, the output gearwheel can, for example, be arranged on the driven shaft. In particular, it is conceivable for the output gearwheel to be connected, in particular permanently, to the driven shaft in a manner fixed against rotation. The output gearwheel interlocks with a first input gearwheel, which is, for example, the previously specified third gearwheel of the first spur gear stage. The first input gearwheel is or can be connected to the third element in a manner fixed against rotation.

It is further provided that the rotor of the electric machine is or can be coupled to one of the elements in a torque-transmitting manner such that the respective second drive torque that is or can be provided by the electric machine via the rotor can be introduced into the transmission at the one element that is or can be coupled to the rotor in a torque-transmitting manner, and thus the respective second drive torque that is or can be provided by the electric machine via the rotor can be transmitted from the rotor to the one element that is or can be coupled to the rotor in a torque-transmitting manner, and can thus be introduced into the transmission via the one element that is or can be coupled to the rotor in a torque-transmitting manner, in particular in order thus to start the transmission.

The hybrid drive system additionally comprises a driven gearwheel, which is, for example, a fourth gearwheel of the hybrid drive system. In particular, the fourth gearwheel is provided in addition to the first gearwheel, in addition to the second gearwheel, and in addition to the third gearwheel. The driven gearwheel is permanently connected to the driven shaft in a manner fixed against rotation. In particular, the driven gearwheel is preferably arranged coaxially with the output gearwheel. The driven gearwheel interlocks permanently with the axial transmission input gear. In particular, it is conceivable for the driven gearwheel to be in the form of a bevel gear.

In the context of the present disclosure, the feature that two components, e.g., the first input gearwheel and the first element, are connected to each other in a manner fixed against rotation should be understood to mean that the components that are connected to each other in a manner fixed against rotation are arranged coaxially with each other and, in particular when the components are driven, rotate together or simultaneously, in particular relative to the housing, with the same angular velocity around a component axis of rotation shared by the components, e.g., the first planetary gear set axis of rotation. The feature that two components, e.g., the rotor and the one element, are coupled or connected to each other in a torque-transmitting manner should be understood to mean that the components are coupled or connected to each other such that torques can be transmitted between components, wherein when the components are connected to each other in a manner fixed against rotation, the components are also connected to each other in a torque-transmitting manner.

The feature that two components are permanently connected to each other in a torque-transmitting manner should be understood to mean that a switching element is not provided that can be switched between a coupled state that connects the components to each other in a torque-transmitting manner and a decoupled state in which no torques can be transmitted between the components, and instead the components are continuously or always, and thus permanently connected to each other in a torque-transmitting manner, i.e., are connected to each other such that a torque can be transmitted between the components. One of the components can thus, for example, be driven by the respective other component or vice versa. In particular, the feature that two components, e.g., the driven gearwheel and the driven shaft, are permanently connected to each other in a manner fixed against rotation should be understood to mean that a switching element is not provided that can be switched between a coupled state that connects the components to each other in a manner fixed against rotation and a decoupled state in which the components are decoupled from each other and can be rotated relative to each other, in particular around the component axis of rotation, such that, for example, no torques can be transmitted between the components, and instead the components are continuously or always, and thus permanently connected or coupled to each other in a manner fixed against rotation. In the context of the present disclosure, by a connection fixed against rotation of two, in particular, rotatably mounted elements is thus meant that these two elements are arranged coaxially with each other and are connected to each other such that they rotate at the same angular velocity. In particular, the feature that two components, e.g., the rotor of the electric machine and the one element, can be coupled or connected to each other in a torque-transmitting manner, in particular in a manner fixed against rotation, should be understood to mean that a switching element also described as a switch element is assigned to the components, which can be switched between a coupled state, in which the components are connected to each other in a torque-transmitting manner, in particular in a manner fixed against rotation, by means of the switched element, and a decoupled state, in which the components are decoupled from each other, such that the components can rotate relative to each other, in particular around the component axis of rotation, and such that, in particular, no torques can be transmitted between the components.

The one element previously specified that is or can be coupled with the rotor of the electric machine in a torque-transmitting manner is also described in the following as a first connecting element, such that in the following reference can unambiguously be made to the first connecting element if this is required.

The hybrid drive system has a first switch element, which is designed to connect the drive shaft of the internal combustion engine to one of the elements in a manner fixed against rotation. In other words, the drive shaft can be connected to one of the elements in a manner fixed against rotation by means of the first switch element. The one element that can be connected to the drive shaft—for example in the form of a crankshaft—of the connecting element in a manner fixed against rotation by means of the first switch element is also described in the following as a second connecting element, such that in the following reference can unambiguously be made to the second connecting element if this is required. The second connecting element can be the first connecting element, or the second connecting element is preferably a different element from the first connecting element. In particular, the first switch element can be switched between a first coupled state and a first decoupled state. In the first coupled state, the drive shaft and the second connecting element are connected to each other in a manner fixed against rotation by means of the first switch element, such that the drive shaft and the second connecting element rotate or can rotate together or simultaneously, i.e., at the same annular velocity, in particular around one of the planetary gear set axes of rotation and/or relative to the housing, in particular when, for example, the drive shaft drives the second connecting element. In the first decoupled state, the first switch element permits relative rotations, in particular implemented around one of the planetary gear set axes of rotation, between the drive shaft and the second connecting element. For example, the first switch element can be moved, in particular translationally and/or relative to the housing, between at least one first coupled position causing the first coupled state and at least one first decoupled position causing the first decoupled state.

In order to be able to implement a particularly advantageous drive, and thus a particularly advantageous drivability of the motor vehicle, a third switch element is provided in a manner known per se, the third switch element being designed to connect the first element to the fifth element in a manner fixed against rotation. This means that the first element and the fifth element can be connected to each other in a manner fixed against rotation by means of the third switch element. In particular, it is conceivable that the third switch element can be switched between a third coupled state and a third decoupled state. In the third coupled state, the first element and the fifth element are connected to each other in a manner fixed against rotation by means of the third switch element, such that the first element and the fifth element rotate or can rotate simultaneously or together, i.e., at the same angular velocity, in particular relative to the housing and/or around the first or second planetary gear set axis of rotation, in particular when the first partial transmission is driven. In the third decoupled state, the third switch element in particular permits relative rotations between the first element and the fifth element implemented around the first or second planetary gear set axis of rotation, such that the first element and the fifth element can in particular rotate relative to each other around the first or second planetary gear set axis of rotation. For example, the third switch element can be moved, in particular translationally and/or relative to the housing, between at least one third coupled position causing the third coupled state and at least one third decoupled position causing the third decoupled state.

According to the invention, the hybrid drive system comprises a second switch element, which is designed to connect the first element to the fourth element in a manner fixed against rotation. In other words, the first element can be connected to the fourth element in a manner fixed against rotation by means of the second switch element. Thus, in particular, the second switch element can be switched between a second coupled state and a second decoupled state. In the second coupled state, the first element and the fourth element are connected to each other in a manner fixed against rotation by means of the second switch element, such that the first element and the fourth element rotate or can rotate together or simultaneously, i.e., at the same angular velocity, in particular around the first planetary gear set axis of rotation or around the second planetary gear set axis of rotation and/or relative to the housing, in particular when the first partial transmission is driven. In the second decoupled state, the second switch element in particular permits relative rotations between the first element and the fourth element implemented around the first and/or second planetary gear set axis of rotation, such that in the second decoupled state, the first element and the fourth element can rotate relative to each other, in particular around the first or second planetary gear set axis of rotation. For example, the second switch element can be moved, in particular translationally and/or relative to the housing, between at least one second coupled position causing the second coupled state and at least one second decoupled position causing the second decoupled state.

According to the invention, the partial transmission further has a second spur gear stage, which, for example, has a fifth gearwheel and a sixth gearwheel. For example, the fifth gearwheel and the sixth gearwheel interlock with each other, in particular permanently. It is further conceivable for the fifth gearwheel and the sixth gearwheel to be in the form of spur gears. The second spur gear stage has a second output gearwheel, which is preferably the fifth gearwheel. The second output gearwheel is connected, in particular permanently, to the driven shaft in a manner fixed against rotation. The second output gearwheel interlocks with a second input gearwheel, which is preferably the sixth gearwheel. The second input gearwheel is or can be connected to the fifth element in a manner fixed against rotation. The second gearwheel can in particular be connected to the fifth element in a manner fixed against rotation.

In order to be able to implement a particularly advantageous multi-gear capability, and thus a particularly advantageous drive, according to the invention, the hybrid drive system further has a fifth switch element, which is designed to connect the second input gearwheel to the fourth element in a manner fixed against rotation. Thus, for example, the fifth switch element can be switched between a fifth coupled state and a fifth decoupled state. In the fifth coupled state, the second input gearwheel and the fourth element are connected to each other in a manner fixed against rotation by means of the fifth switch element, such that the second input gearwheel and the fourth element rotate or can rotate together or simultaneously, i.e., at the same angular velocity, in particular relative to the housing and/or around the second planetary gear set axis of rotation, in particular when the first partial transmission is driven. In the fifth decoupled state, the fifth switch element in particular permits relative rotations between the second input gearwheel and the fourth element implemented around the second planetary gear set axis of rotation. For example, the fifth switch element can be moved, in particular relative to the housing and/or translationally, between at least one fifth coupled position causing the fifth coupled state and at least one fifth decoupled position causing the fifth decoupled state.

In the context of the present disclosure, ordinal numerals also described as ordinals, e.g., “first”, second” etc., are not necessarily used to specify or imply a number or quantity, but rather to be able to unambiguously reference terms to which the ordinal numerals are assigned or to which the ordinal numerals relate.

In a particularly advantageous embodiment of the invention, the first switch element is designed to connect the drive shaft to the first element in a manner fixed against rotation. In other words, it has proved particularly advantageous if the second connecting element is the first element. A particularly good drivability can thus be achieved.

A second embodiment is characterized in that the rotor of the electric machine is permanently coupled to the fourth element in a torque-transmitting manner such that the respective second drive torque that is or can be provided by the electric machine via the rotor can be introduced to a fourth element, i.e., can be introduced into the transmission via the fourth element. The particularly good drivability, and thus the particularly good drive can thus be achieved.

Particularly preferably, it is provided that the first element is the first sun gear, the second element is the first planetary carrier, and the third element is the first annular gear. As an alternative or in addition, it is preferably provided that the fourth element is the second sun gear, the fifth element is the second planetary carrier, and the sixth element is the third annular gear.

To be able to represent a particularly advantageous drive in a particularly space-, cost-, and weight-saving manner, it is provided in a further embodiment of the invention that the hybrid drive system has exactly, i.e., exclusively, two planetary gear sets in total, specifically the first planetary gear set and the second planetary gear set.

It is conceivable that the first input gearwheel is permanently connected to the first element in a manner fixed against rotation.

In a further embodiment of the invention, the hybrid drive system comprises a fourth switch element, which is designed to connect the second input gearwheel to the fifth element in a manner fixed against rotation. A particularly advantageous multi-gear capability can thus be achieved in a particularly space-saving manner, such that a particularly good drivability and thus a particularly good drive can be implemented. In particular, the fourth switch element can thus, for example, be switched between a fourth coupled state and a fourth decoupled state. In the fourth coupled state, the second input gearwheel and the fifth element are connected to each other in a manner fixed against rotation by means of the fourth switch element, such that the input gearwheel and the fifth element rotate or can rotate simultaneously or together, i.e., at the same angular velocity, in particular relative to the housing and/or around the second planetary gear set axis of rotation, in particular when the first partial transmission is driven. In the fourth decoupled state, the fourth switch element permits relative rotations between the second input gearwheel and the fifth element in particular implemented around the second planetary gear set axis of rotation. For example, the fourth switch element can be moved, in particular relative to the housing and/or translationally, between at least one fourth coupled position causing the fourth coupled state and at least one fourth decoupled position causing the fourth decoupled state.

To be able to implement a particularly advantageous drivability in a particularly space-saving manner, it is provided in a further embodiment of the invention that, when viewed in the axial direction of the drive shaft, the internal combustion engine, the driven gearwheel, the first spur gear stage, the first partial transmission, and the second spur gear stage are arranged one after the other, i.e., one behind the other, in the following order: the internal combustion engine—the driven gearwheel—the first spur gear stage—the first partial transmission—the second spur gear stage. In other words, when viewed in the axial direction of the drive shaft, the driven gearwheel is arranged following the internal combustion engine, the first spur gear stage is arranged following the driven gearwheel, the first partial transmission is arranged following the first spur gear stage and the second spur gear stage is arranged following the first partial transmission.

Finally, it has proved particularly advantageous for implementing a particularly advantageous drivability if the hybrid drive system has a sixth switch element that is designed to connect the first element to the housing of the hybrid drive system in a manner fixed against rotation. The sixth switch element can thus, for example, be switched between a sixth coupled state and a sixth decoupled state. In the sixth coupled state, the first element and the housing are connected to each other in a manner fixed against rotation by means of the sixth switch element, such that, in particular, for example, rotations of the first element implemented around the first planetary gear set axis of rotation and relative to the housing also cease when the first partial transmission is driven, i.e., when torques are introduced into the first partial transmission. In the sixth decoupled state, the sixth switch element permits rotations of the first element implemented around the first planetary gear set axis of rotation and relative to the housing. In other words, in the sixth coupled state, the first element cannot rotate around the first planetary gear set axis of rotation relative to the housing, in particular even when the first partial transmission is driven. In the sixth decoupled state, however, the first element can rotate around the first planetary gear set axis of rotation relative to the housing, in particular when the first partial transmission is driven. For example, the sixth switch element can be moved, in particular relative to the housing and/or translationally, between at least one sixth coupled position causing the sixth coupled state and at least one sixth decoupled position causing the sixth decoupled state.

In the context of the disclosure, the terms “axial” and “coaxial” relate in particular to the planetary gear set axes of rotation. For example, a drive shaft axis of rotation of the drive shaft runs in parallel with the planetary gear set axis of rotation of the respective planetary gear set or, particularly advantageously, the drive shaft axis of rotation coincides with the planetary gear set axis of rotation, such that, when viewed in the axial direction of the respective planetary gear set, i.e., along the respective planetary gear set axis of rotation, the internal combustion engine, the driven gearwheel, the first spur gear stage, the first partial transmission, and the second spur gear stage are also arranged one after the other in the specified order.

In the context of the present disclosure, the feature “axially overlapping” should be understood to mean that two components are arranged axially overlapping if they are arranged in regions having the same axial coordinates. Thus, in an axially overlapping arrangement, there is at least one radially arranged plane, and thus a plane running in the radial direction of the respective planetary gear set and thus perpendicular to the planetary gear set axis of rotation, said plane penetrating both the one and the other of the axially overlapping components.

A second aspect of the invention relates to a motor vehicle also simply described as a vehicle, which can for example be in the form of a motor car, in particular of a passenger car. The motor vehicle has a hybrid drive system according to the first aspect of the invention. The motor vehicle can be driven by means of the hybrid drive system. Advantages and advantageous embodiments of the first aspect of the invention should be seen as advantages and advantageous embodiments of the second aspect of the invention and vice versa.

Further advantages, features and details of the invention result from the following description of preferred exemplary embodiments and with reference to the drawing. The features and combinations of features previously specified in the description and the features and combinations of features shown in the following in the description of figures and/or in the figures alone can be used not only in the respectively specified combination, but also in other combinations or in isolation without leaving the scope of the invention.

### BRIEF DESCRIPTION OF THE DRAWING FIGURES

In the following, the drawing shows:

FIG. 1 a schematic depiction of a first embodiment of a hybrid drive system for a motor vehicle;

FIG. 2 a schematic depiction of a second embodiment of the hybrid drive system; and

FIG. 3 a schematic depiction of a third embodiment of the hybrid drive system.

Identical or functionally identical elements are provided with the same reference numerals in the figures.

### DETAILED DESCRIPTION

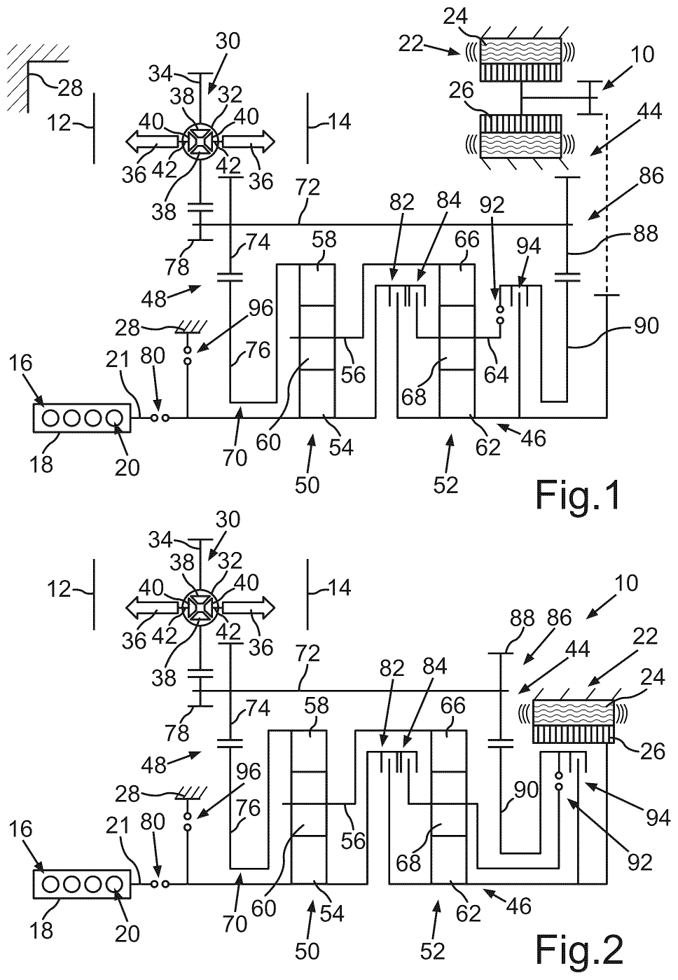

FIG. 1 shows, in a schematic depiction, a first embodiment of a hybrid drive system 10 for a motor vehicle also described as a vehicle. The motor vehicle is preferably in the form of a motor car. For example, the motor vehicle has at least or exactly two vehicle axles arranged one behind the other in the longitudinal direction of the vehicle. The respective vehicle axle is also simply described as an axle and has at least or exactly two vehicle wheels, the vehicle wheels being ground contact elements of the motor vehicle. The hybrid drive system 10 is assigned to one, in particular exactly one, of the axles, such that the vehicle wheels of the vehicle axle to which the hybrid drive system 10 is assigned can be driven by means of the hybrid drive system 10. The vehicle wheels of the vehicle axle to which the hybrid drive system 10 is assigned that can be driven by means of the hybrid drive system 10 are depicted particularly schematically in FIG. 1 and labelled 12 and 14.

The hybrid drive system 10 has an internal combustion engine 16 also described as an internal combustion machine, engine, or combustion machine. The internal combustion engine 16 has a cylinder housing 18, also described as an engine block, the cylinder housing having several cylinders 20. In a fired operation of the internal combustion engine, combustion processes take place in the cylinders 20. For example, the internal combustion engine 16 is in the form of a reciprocating piston engine. The internal combustion engine 16 has a drive shaft 21, for example in the form of a crankshaft, which can be rotated around a drive shaft axis of rotation relative to the cylinder housing 18. The internal combustion engine 16 can provide first drive torques to drive the vehicle wheels 12 and 14 and thus to drive the motor vehicle via the drive shaft 21.

The hybrid drive system 10 additionally comprises an electric machine 22 that has a stator 24 and a rotor 26. The rotor 26 can be driven by means of the stator 24, and can thus rotate around a machine axis of rotation relative to the stator 24. The hybrid drive system 10 additionally comprises a housing 28 depicted particularly schematically in FIG. 1, wherein the drive shaft 21 can be rotated around the drive shaft axis of rotation and the rotor 26 can be rotated around the machine axis of rotation relative to the housing 28. The electric machine 22 can provide second drive torques to drive the vehicle wheels 12 and 14 and thus to drive the motor vehicle via the rotor 26.

The hybrid drive system 10 also has an axial transmission 30 in the form of a differential transmission and also simply described as a differential, via which the vehicle wheels 12 and 14 can be driven by the electric machine 22 and by the internal combustion engine 16. In the first embodiment, the axial transmission 30 is, for example, in the form of a bevel gear differential 30. The axial transmission 30 has an axial transmission housing 32, which, for example, is presently in the form of a so-called differential cage. The axial transmission 30 additionally comprises an axial transmission input gear 34, which is connected, in particular permanently, to the axial transmission housing 32 in a manner fixed against rotation. The axial transmission housing 32 and the axial transmission input gear 34 can thus be rotated around an axial transmission axis of rotation relative to the housing 28. As depicted in FIG. 1 by arrows 36, the axial transmission 30 can distribute or transmit a respective third drive torque resulting from the respective first drive torque and/or from the respective second drive torque, the third drive torque also being described as a third torque, to the vehicle wheels 12 and 14, whereby the vehicle wheels 12 and 14 can be driven.

The axial transmission 30 has pinion gears 38 here in the form of bevel gears, which can rotate with the axial transmission housing 32 around the axial transmission axis of rotation relative to the housing 28. In addition, the pinion gears 38 can rotate around a pinion gear axis of rotation, said pinion gear axis of rotation running perpendicular to the axial transmission axis of rotation. The pinion gears 38 interlock, in particular permanently, with side gears 40 of the axial transmission 30. The respective pinion gear 38 can be rotated relative to the axial transmission housing 32 around the respective pinion gear axis of rotation, which runs perpendicular to the axial transmission axis of rotation. The respective side gear 40 can be rotated relative to the housing 28 and also relative to the axial transmission housing 32 around the axial transmission axis of rotation. The respective side gear 40 is connected, in particular permanently, to a respective side shaft 42 in a manner fixed against rotation, wherein the respective vehicle wheel 12, 14 can be driven by the respective side shaft 42.

The hybrid drive system 10 additionally comprises a transmission 44 also described as a main transmission, which has a first partial transmission 46 and a second partial transmission 48. The first partial transmission 46 has a first planetary gear set 50 and a second planetary gear set 52, which are here arranged coaxially with each other. The first planetary gear set 50 has a first element 54 advantageously in the form of a first sun gear, a second element 56 advantageously in the form of a first planetary carrier, and a third element 58 advantageously in the form of a first annular gear. In addition, the first planetary gear set 50 has first planetary gears 60, which are rotatably mounted on the second element (first planetary carrier) 56 and simultaneously interlock both with the first element 54 and with the third element 58. The second planetary gear set 52 has a fourth element 62 advantageously in the form of a second sun gear, a fifth element 64 advantageously in the form of a second planetary carrier and a sixth element 66 advantageously in the form of a second annular gear. In addition, the first planetary gear set 52 has planetary gears 68, which are rotatably mounted on the fifth element 64 (second planetary carrier) and simultaneously interlock both with the fourth element (sun gear) 62 and with the sixth element 66 (second annular gear). The sixth element 66 is permanently connected to the second element 56 in a manner fixed against rotation.

The second partial transmission 48 has a first spur gear stage 70. The second partial transmission 48 additionally comprises a driven shaft 72, which can be rotated around a driven shaft axis of rotation relative to the housing 28. In particular when the respective element is not connected to the housing in a manner fixed against rotation, the respective element can be rotated around a planetary gear set axis of rotation relative to the housing 28. The planetary gear set axis of rotation is a planetary gear set axis of rotation shared by the planetary gear sets 50 and 52 because the planetary gear sets 50 and 52 are arranged coaxially with each other.

In the first embodiment, the internal combustion engine 16 or the drive shaft 21 is arranged coaxially with the planetary gear sets 50 and 52 such that the drive shaft axis of rotation coincides with the planetary gear set axis of rotation. The drive shaft 72 is arranged axially in parallel with the planetary gear sets 50, and also with the drive shaft 21 such that the driven shaft axis of rotation runs in parallel with the planetary gear set axis of rotation and in parallel with the drive shaft axis of rotation and is spaced apart from the planetary gear set axis of rotation and from the drive shaft axis of rotation. The electric machine 22, i.e., its rotor 26, is arranged axially in parallel with the driven shaft 72, axially in parallel with the planetary gear sets 50 and 52 and axially in parallel with the internal combustion engine 16 such that the machine axis of rotation runs in parallel with the driven shaft axis of rotation, in parallel with the planetary gear set axis of rotation and in parallel with the drive shaft axis of rotation and is spaced apart from the driven shaft axis of rotation, from the planetary gear set axis of rotation and from the drive shaft axis of rotation. The axial transmission axis of rotation here runs in parallel with the machine axis of rotation, in parallel with the driven shaft axis of rotation, in parallel with the planetary gear set axis of rotation and in parallel with the drive shaft axis of rotation and is spaced apart from the aforementioned axes of rotation.

The first spur gear stage 70 has a first output gearwheel 74, which is arranged coaxially with the driven shaft 72. In the first embodiment, the output gearwheel 74 is connected, in particular permanently, to the driven shaft 72 in a manner fixed against rotation. It is further conceivable that the output gearwheel 74 is arranged on the driven shaft 72. The first spur gear stage 70 additionally comprises an input gearwheel 76, which interlocks, in particular permanently, with the first output gearwheel 74. In the first embodiment, the first input gearwheel 76 is connected, in particular permanently, to the third element (annular gear) 58.

In the first embodiment, the rotor 26 is coupled, in particular permanently, to the fourth element (second sun gear) 62 in a torque-transmitting manner such that the respective second drive torque that is or can be provided by the electric machine 22 via its rotor or a torque resulting from said second drive torque can be introduced into the transmission 44 at the fourth element 62. The hybrid drive system 10 additionally comprises a driven gearwheel 78, which is permanently connected to the driven shaft 72 in a manner fixed against rotation, and is thus arranged coaxially with the driven shaft 72 and coaxially with the output gearwheel 74. The driven gearwheel 78 interlocks permanently with the axial transmission input gear 34 of the axial transmission 30, of which the axial transmission input gear 34 is a gearwheel, for example a crown gear. The hybrid drive system 10 has a first switch element 80 also labelled KO, which is designed to connect the drive shaft 21 to the first element 54 in a manner fixed against rotation. For example, the first switch element 80 is a friction coupling, in particular a disc coupling. A second switch element 82 is also provided, which is designed to connect the first element 54 to the fourth element (second sun gear) 62 in a manner fixed against rotation.

The hybrid drive system 10 further comprises a third switch element 84, which is designed to connect the first element 54 to the fifth element (second planetary carrier) 64 in a manner fixed against rotation. In the first embodiment, the hybrid drive system 10 has exactly two planetary gear sets in total, specifically the gear sets 50 and 52.

The second partial transmission 48 has a second spur gear stage 86, which comprises a second output gearwheel 88 that is connected, in particular permanently, to the driven shaft 72 in a manner fixed against rotation. The spur gear stage 86 additionally comprises a second input gearwheel 90, which interlocks, in particular permanently, with the output gearwheel 88. In the first embodiment, the input gearwheel 90 can be connected to the fifth element (second planetary carrier) 64. A fourth switch element 92 is further provided, which is designed to connect the second input gearwheel 90 to the fifth element (second planetary carrier) 64 in a manner fixed against rotation. A fifth switch element 94 is further provided, which is designed to connect the second input gearwheel 90 to the fourth element (second sun gear) 62 in a manner fixed against rotation. A sixth switch element 96 is further provided, which is designed to connect the first element 54 to the housing 28 in a manner fixed against rotation.

When viewed in the axial direction of the respective planetary gear set 50, 52, and thus along the planetary gear set axis of rotation, and when viewed in the axial direction of the drive shaft 21, the internal combustion engine 16, the driven gearwheel 78, the first spur gear stage 70, the first partial transmission 46, and the second spur gear stage 86 are arranged one behind the other, i.e., one after the other in the following order, i.e., in the following order: The internal combustion engine 16—the driven gearwheel 78—the first spur gear stage 70—the first partial transmission 46—the second spur gear stage 86.

FIG. 2 shows, in a schematic depiction, a second embodiment of the hybrid drive system 10. In the second embodiment, the rotor 26 is connected, in particular permanently, to the fourth element 62 (second sun gear) in a manner fixed against rotation, and is thus in particular permanently coupled in a torque-transmitting manner. While in the first embodiment, for example, the second spur gear stage 86 and/or the planetary gear set 52 is arranged axially overlapping the rotor 26, in particular the electric machine 22, it is provided in the second embodiment that the rotor 26, in particular the electric machine 22, is completely connected both to the planetary gear set 52 and to the second spur gear stage 86 when viewed in the axial direction of the respective planetary gear set 50, 52, in particular such that, when viewed in the axial direction of the respective planetary gear set 50, 52, the planetary gear set 52, the second spur gear stage 86 and the electric machines 22 are arranged one after the other in the following order: The planetary gear set 52—the second spur gear stage 86—the electric machine 22.

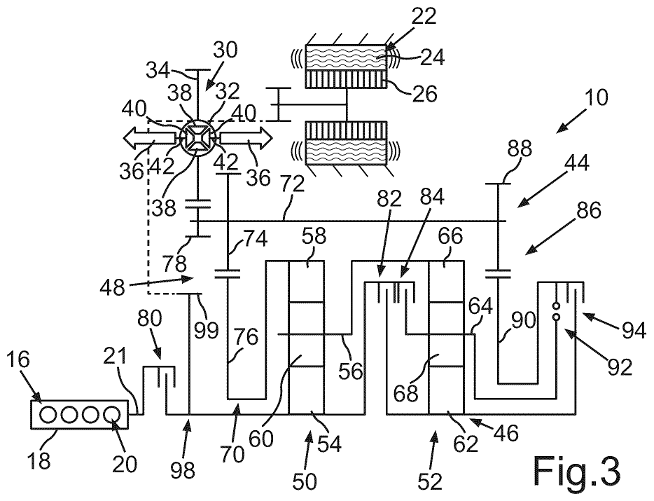

FIG. 3 shows a third embodiment of the hybrid drive system 10. In the third embodiment, the rotor 26 is permanently coupled to the first element (first sun gear) 54 in a torque-transmitting manner. The rotor 26 is particularly advantageously permanently coupled to the first element 54 in a torque-transmitting manner via a third spur gear stage 98.

The third spur gear stage 98 particularly advantageously has a third input gearwheel 99, which is connected to the first element 54 in a manner fixed against rotation and which is arranged between the first spur gear stage 70 and the first switch element 80 in relation to the axial direction. Advantageously, a gearwheel that is connected to the rotor 26 in a manner fixed against rotation engages permanently with the third input gearwheel 99 or is coupled to the third input gearwheel 99 via a further spur gear stage (not depicted) or via a chain drive.

In addition, in the third embodiment, the rotor 26, in particular the electric machine 22, is arranged axially overlapping at least the first planetary gear set 50. Mostly particularly advantageously (although not depicted as such in FIG. 3), the rotor 26 is arranged both axially overlapping the first planetary gear set 50 and axially overlapping the second planetary gear set 52.

The switch element 96 is not present in the third embodiment. In the third embodiment, when viewed in the axial direction of the respective planetary gear set 50, 52, the spur gear stages 70 and 86 and the electric machines 22 are advantageously arranged one after the other in the following order: first spur gear stage 70—electric machine 22—second spur gear stage 86.

In the second embodiment, however, when viewed in the axial direction of the respective planetary gear set 50, 52, the spur gear stages 70 and 86 and the electric machine 22 are arranged one behind the other in the following order: first spur gear stage 70—second spur gear stage 86—electric machines 22.

In the first embodiment, the electric machines 22 and the second spur gear stage 86 are arranged at least partially axially overlapping one another. Just as in the second embodiment, this is also the case in the third embodiment, because in the second embodiment and in the third embodiment, when viewed in the axial direction of the respective planetary gear set 50, 52, the electric machine 22 is completely connected to the second spur gear stage 86, specifically in a direction pointing away from the first spur gear stage 70 in the second embodiment, in a direction pointing towards the first spur gear stage 70 in the third embodiment.

Overall, it can be seen that the transmission 44 can particularly advantageously be realized as a multi-stage transmission, in particular on the basis of coupled planetary gear sets in the form of the planetary gear sets 50 and 52, and in particular in an axially parallel design and with a low power loss. In particular, up to five hybrid or internal combustion engine forward gears, at least three electric gears and various stepless drive ranges can be achieved. A large spread can be achieved. For this purpose, only the exactly two planetary gear sets 50 and 52 are used, in particular in the form of single planetary gear sets, spur gear transmission ratios in the form of the spur gear stages 70 and 86 and, in particular exactly, five or six switch elements. At least two of the switch elements can be designed as form-fit switch elements, in particular as claw couplings, in particular with or without a synchronization unit, so that losses can thus be kept particularly low. Good gearing efficiencies, and thus a particularly low-loss operation can be realized. A coaxial planetary gear set design having two output drives that are axially in parallel can thus be created that is particularly advantageous for a front-wheel drive in a transverse installation. The electric machine 72 can be arranged coaxially or axially in parallel. In particular, in the case of an arrangement of the electric machines 22 axially in parallel, said electric machines can advantageously be arranged at the back. A coaxial arrangement of the electric machines 22 offers the possibility of placing switch elements in their interior. At least two of the switch elements can be implemented as claw switch elements or form-fit switch elements, wherein further, form-fit switch elements, in particular claw switch elements, are conceivable, in particular by using the electric machine 22. For example, the switch element 96 can be dispensed with, so that the number of parts, the costs, the weight and the required installation space can be kept particularly low. A possible traction compensation is possible via an arrangement of the electric machines 22 axially in parallel and in particular via a corresponding transmission ratio.

### LIST OF REFERENCE NUMERALS

10 hybrid drive system
12 vehicle wheel
14 vehicle wheel
16 internal combustion engine
18 cylinder housing
20 cylinder
21 drive shaft
22 electric machine
24 stator
26 rotor
28 housing
30 axial transmission
32 axial transmission housing
34 axial transmission input gear
36 arrow
38 pinion gear
40 side gear
42 side shaft
44 transmission
46 first partial transmission
48 second partial transmission
50 first planetary gear set
52 second planetary gear set
54 first element
56 second element
58 third element
60 planetary gear
62 fourth element
64 fifth element
66 sixth element
68 planetary gear
70 first spur gear stage
72 driven shaft
74 first output gearwheel
76 first input gearwheel
78 driven gearwheel
80 first switch element
82 second switch element
84 third switch element
86 second spur gear stage
88 second output gearwheel
90 second input gearwheel
92 fourth switch element
94 fifth switch element
96 sixth switch element
98 third spur gear stage
99 third input gearwheel

1-10. (canceled)

11. A hybrid drive system for a motor vehicle, the hybrid drive system comprising:
an internal combustion engine having a drive shaft via which first drive torques are providable by the internal combustion engine to drive the motor vehicle;
an electric machine having a rotor via which second drive torques are providable by the electric machine to drive the motor vehicle;
an axial transmission having an axial transmission input gear via which the axial transmission is drivable; and
a transmission having a first partial transmission and a second partial transmission, wherein
the first partial transmission has a first planetary gear set having a first element, a second element, and a third element, and a second planetary gear set having a fourth element, a fifth element, and a sixth element that is permanently connected to the second element in a manner fixed against rotation,
the second partial transmission has a first spur gear stage and a driven shaft,
the first spur gear stage has a first output gearwheel arranged coaxially with the driven shaft and interlocking with a first input gearwheel that is connected or is connectable to the third element in a manner fixed against rotation,
the rotor of the electric machine is coupled or is couplable to one of the first, second, third, fourth, fifth, and sixth elements in a torque-transmitting manner such that the respective second drive torque provided by the electric machine via the rotor is introducible into the transmission at the one of the first, second, third, fourth, fifth, and sixth elements that is coupled or is couplable to the rotor in a torque-transmitting manner;
a driven gearwheel permanently connected to the driven shaft in a manner fixed against rotation and permanently interlocking with the axial transmission input gear of the axial transmission;
a first switch element configured to connect the drive shaft of the internal combustion engine to one of the first, second, third, fourth, fifth, and sixth elements in a manner fixed against rotation;
a third switch element configured to connect the first element to the fifth element in a manner fixed against rotation;
a second switch element configured to connect the first element to the fourth element in a manner fixed against rotation, wherein the second partial transmission has a second spur gear stage, which has a second output gearwheel that is connected to the driven shaft in a manner fixed against rotation and interlocks with a second input gearwheel that is connected to or connectable to the fifth element in a manner fixed against rotation; and
a fifth switch element configured to connect the second input gearwheel to the fourth element in a manner fixed against rotation.

12. The hybrid drive system of claim 11, wherein the third switch element is configured to connect the drive shaft to the first element in a manner fixed against rotation.

13. The hybrid drive system of claim 11, wherein the hybrid drive system has exactly two planetary gear sets in total, which are the first planetary gear set and the second planetary gear set.

14. The hybrid drive system of claim 11, further comprising:
a fourth switch element configured to connect the second input gearwheel to the fifth element in a manner fixed against rotation.

15. The hybrid drive system of claim 11, wherein, when viewed in an axial direction of a respective one of the first and second planetary gear sets, the internal combustion engine, the driven gearwheel, the first spur gear stage, the first partial transmission, and the second spur gear stage are arranged one after another in a following order: the internal combustion engine, the driven gearwheel, the first spur gear stage, the first partial transmission, and the second spur gear stage.

16. The hybrid drive system of claim 11, further comprising:
a sixth switch element configured to connect the first element to a housing of the hybrid drive system in a manner fixed against rotation.

17. The hybrid drive system of claim 11, wherein the rotor of the electric machine is permanently coupled or is permanently couplable to the fourth element in a torque-transmitting manner such that the respective second drive torque provided by the electric machine via the rotor is introducible into the transmission at the fourth element.

18. The hybrid drive system of claim 11, wherein the rotor of the electric machine is permanently coupled to the first element in a torque-transmitting manner such that the respective second drive torque provided by the electric machine via the rotor is introducible into the transmission at the first element.

19. The hybrid drive system of claim 18, further comprising:
a third input gearwheel connected to the first element in a manner fixed against rotation and which is arranged axially between the first spur gear stage and the first switch element, wherein the respective second drive torque provided by the electric machine via the rotor is introducible into the transmission at the third input gearwheel.

20. A motor vehicle, comprising:
a hybrid drive system, which comprises
an internal combustion engine having a drive shaft via which first drive torques are providable by the internal combustion engine to drive the motor vehicle;
an electric machine having a rotor via which second drive torques are providable by the electric machine to drive the motor vehicle;
an axial transmission having an axial transmission input gear via which the axial transmission is drivable; and
a transmission having a first partial transmission and a second partial transmission, wherein
the first partial transmission has a first planetary gear set having a first element, a second element, and a third element, and a second planetary gear set having a fourth element, a fifth element, and a sixth element that is permanently connected to the second element in a manner fixed against rotation,
the second partial transmission has a first spur gear stage and a driven shaft,
the first spur gear stage has a first output gearwheel arranged coaxially with the driven shaft and interlocking with a first input gearwheel that is connected or is connectable to the third element in a manner fixed against rotation,
the rotor of the electric machine is coupled or is couplable to one of the first, second, third, fourth, fifth, and sixth elements in a torque-transmitting manner such that the respective second drive torque provided by the electric machine via the rotor is introducible into the transmission at the one of the first, second, third, fourth, fifth, and sixth elements that is coupled or is couplable to the rotor in a torque-transmitting manner;
a driven gearwheel permanently connected to the driven shaft in a manner fixed against rotation and permanently interlocking with the axial transmission input gear of the axial transmission;
a first switch element configured to connect the drive shaft of the internal combustion engine to one of the first, second, third, fourth, fifth, and sixth elements in a manner fixed against rotation;
a third switch element configured to connect the first element to the fifth element in a manner fixed against rotation;
a second switch element configured to connect the first element to the fourth element in a manner fixed against rotation, wherein the second partial transmission has a second spur gear stage, which has a second output gearwheel that is connected to the driven shaft in a manner fixed against rotation and interlocks with a second input gearwheel that is connected to or connectable to the fifth element in a manner fixed against rotation; and
a fifth switch element configured to connect the second input gearwheel to the fourth element in a manner fixed against rotation.
